(19) United States
(12) Patent Application Publication
(10) Pub. No.: US 2026/0096613 A1
(43) Pub. Date: Apr. 9, 2026

(54) MEASUREMENT DEVICE AND AGRICULTURAL PRODUCT PRODUCTION METHOD

(71) Applicant: FUJIFILM Business Innovation Corp., Tokyo (JP)

(72) Inventors: Kazuhiko ARAI, Kanagawa (JP); Mizuki SUGINO, Kanagawa (JP); Hideaki OZAWA, Kanagawa (JP); Kohei TAKAHASHI, Kanagawa (JP); Akihiro TAKAHASHI, Kanagawa (JP)

(73) Assignee: FUJIFILM Business Innovation Corp., Tokyo (JP)

(21) Appl. No.: 19/197,489

(22) Filed: May 2, 2025

(30) Foreign Application Priority Data
Oct. 7, 2024 (JP) 2024-175530

(51) Int. Cl. A41D 19/00; G01L 9/00

(52) U.S. Cl. CPC A41D 19/0027; G01L 9/0051

(57) ABSTRACT

A measurement device includes: a holding unit that is deformed in accordance with motion of a hand of a user to push or hold an agricultural product; and a measurement unit that is provided on the holding unit to measure an internal state of the agricultural product being pushed or held.

### CROSS-REFERENCE TO RELATED APPLICATIONS

This application is based on and claims priority under 35 USC 119 from Japanese Patent Application No. 2024-175530 filed Oct. 7, 2024.

### BACKGROUND

### (i) Technical Field

The present disclosure relates to a measurement device and an agricultural product production method.

### (ii) Related Art

Japanese Unexamined Patent Application Publication No. 9-49817 describes a greengrocery product internal quality inspection method including inducing a current at a specific frequency in a greengrocery product, measuring at least electrical properties of the greengrocery product that vary in correspondence with a loss of water and a reduction in acidity, and inspecting the internal quality of the greengrocery product using the electrical properties as an index.

### SUMMARY

There is known a device that checks the internal state of an agricultural product in a non-destructive manner. In the related art, it is necessary to perform the action of measuring the internal state of an agricultural product in a process that is separate from other actions such as a harvesting action performed during harvest, for example.

Aspects of non-limiting embodiments of the present disclosure relate to providing a measurement device capable of measuring the internal state of an agricultural product in the same process as other actions.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a measurement device including: a holding unit that is deformed in accordance with motion of a hand of a user to push or hold an agricultural product; and a measurement unit that is provided on the holding unit to measure an internal state of the agricultural product being pushed or held.

### BRIEF DESCRIPTION OF THE DRAWINGS

An exemplary embodiment of the present disclosure will be described in detail based on the following figure, wherein:

FIGS. 1A and 1B illustrate an example of the configuration of a measurement device according to the present exemplary embodiment, in which FIG. 1A illustrates the measurement device as seen from the palm side, and FIG. 1B illustrates the measurement device as seen from the back-of-the-hand side;

FIG. 2 illustrates an example of the configuration of an electrode;

FIG. 3 illustrates an example of the hardware configuration of a control device;

FIG. 4 illustrates an example of the functional configuration of the control device;

FIG. 5 indicates the relationship between the pressure and the measurement result of the impedance;

FIGS. 6A to 6C indicate temporal variations in the impedance of Shine Muscat, in which FIG. 6A indicates measurement values for three grains on the vine side, FIG. 6B indicates measurement values for three grains at the middle, and FIG. 6C indicates measurement values for three grains on the lower side;

FIG. 7 indicates the relationship between the impedance and the sugar content;

FIGS. 8A and 8B indicate a comparison between sugar content values calculated from the impedance and actually measured sugar content values, in which FIG. 8A indicates the result for a case where a correction is not performed in accordance with the inter-electrode distance, and FIG. 8B indicates the result for a case where a correction is performed in accordance with the inter-electrode distance;

FIG. 9 indicates the result of evaluating the applicable range of the measurement device;

FIG. 10 is a flowchart illustrating an example of a process flow by the control device; and

FIG. 11 is a flowchart illustrating an example of a method of measuring the internal state of an agricultural product in a production process of the agricultural product.

### DETAILED DESCRIPTION

An exemplary embodiment of the present disclosure will be described in detail below with reference to the accompanying drawings.

### Configuration of Measurement Device

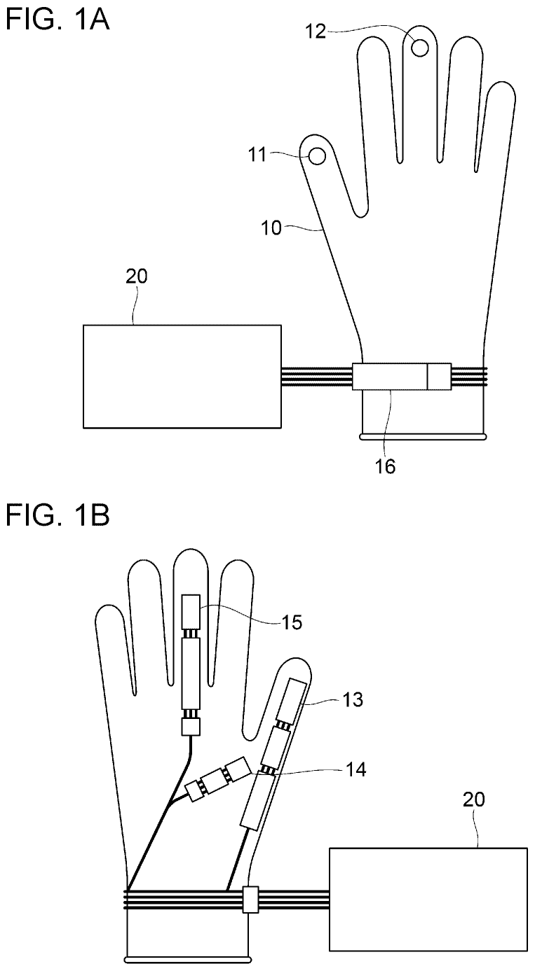

FIGS. 1A and 1B illustrate an example of the configuration of a measurement device 1 according to the present exemplary embodiment. FIG. 1A illustrates the measurement device as seen from the palm side, and FIG. 1B illustrates the measurement device as seen from the back-of-the-hand side.

The measurement device 1 includes a holding unit 10, a first electrode 11, a second electrode 12, a first distance sensor 13, a second distance sensor 14, a third distance sensor 15, a display unit 16, and a control device 20.

The holding unit 10 varies in shape in accordance with motion of a hand of a user. The user pushes or holds an agricultural product via the holding unit 10, depending on the size of the agricultural product. In the example illustrated in FIGS. 1A and 1B, the holding unit 10 is in a glove shape to be worn on a hand of the user.

The shape of the holding unit 10 is not limited to the glove shape, and the holding unit 10 may be shaped to be placed on a hand to be used, or may be shaped to be worn on a finger to be used, for example. The holding unit 10 may be a rectangular cloth, a finger stall, or the like, for example. The holding unit 10 may be positioned between a hand or a finger of the user and the agricultural product when the user touches the agricultural product. When the agricultural product is a big article such as a watermelon, the user pushes the agricultural product via the holding unit 10. When the agricultural product is a small article such as a kiwifruit, the user grabs the agricultural product via the holding unit 10.

The first electrode 11 and the second electrode 12 are provided on the holding unit 10, and measure the internal state of the agricultural product. In the example illustrated in FIGS. 1A and 1B, the first electrode 11 is provided at the thumb portion of the holding unit 10, and the second electrode 12 is provided at the middle finger portion of the holding unit 10. In the present exemplary embodiment, a voltage is applied to one of the electrodes, and the impedance (Z) of the agricultural product is measured from a current that flows between the electrodes. The voltage applied to the electrodes is an alternating voltage, for example, and the frequency of the alternating voltage is set to be different in accordance with the kind of the agricultural product. The frequency of the alternating voltage is set in accordance with the vibration characteristics of the inside of the agricultural product. This improves the accuracy in measuring the internal state.

The first electrode 11 and the second electrode 12 are an example of a measurement unit. Hereinafter, the first electrode 11 and the second electrode 12 will be occasionally referred to simply as “electrodes” when the first electrode 11 and the second electrode 12 are not differentiated from each other.

The first distance sensor 13, the second distance sensor 14, and the third distance sensor 15 measure the distance between the first electrode 11 and the second electrode 12. The first distance sensor 13, the second distance sensor 14, and the third distance sensor 15 are bend distance sensors, for example, and measure a bend from a resistance that varies in accordance with the bend. The first distance sensor 13 is provided at the thumb portion of the holding unit 10, and measures a bend of the thumb. The second distance sensor 14 is provided at the root portion of the thumb of the holding unit 10, and measures a bend of the root of the thumb. The third distance sensor 15 is provided at the middle finger portion of the holding unit 10, and measures a bend of the middle finger. The distance between the electrodes is calculated from the bend of each portion.

The first distance sensor 13, the second distance sensor 14, and the third distance sensor 15 are an example of a distance measurement unit. Hereinafter, the first distance sensor 13, the second distance sensor 14, and the third distance sensor 15 will be occasionally referred to simply as “distance sensors” when the first distance sensor 13, the second distance sensor 14, and the third distance sensor 15 are not differentiated from each other.

The display unit 16 displays a measurement result. In the example illustrated in FIGS. 1A and 1B, the display unit 16 is provided at the wrist portion of the user. The display unit 16 displays a sugar content calculated on the basis of the impedance, for example, as the measurement result. The display unit 16 may also display whether the measurement result is good or not. Whether the measurement result is good or not may be whether the agricultural product is ready to harvest or not, for example. Whether the measurement result is good or not may be indicated to the user by a sound, besides being displayed on the display unit 16.

The display unit 16 is an example of an output unit.

The control device 20 controls measurement by the measurement device 1. The control device 20 is configured to be mountable to the wrist or arm portion of the user, for example, reducing the burden of carrying the control device 20.

The control device 20 is connected to the first electrode 11 and the second electrode 12, and controls the voltage to be applied to the electrodes. In addition, the control device 20 acquires the current that flows between the electrodes, and calculates the impedance of the agricultural product.

In addition, the control device 20 is connected to the first distance sensor 13, the second distance sensor 14, and the third distance sensor 15, and calculates the distance between the electrodes. In addition, the control device 20 controls output on the display unit 16. The configuration of the control device 20 will be discussed in detail later.

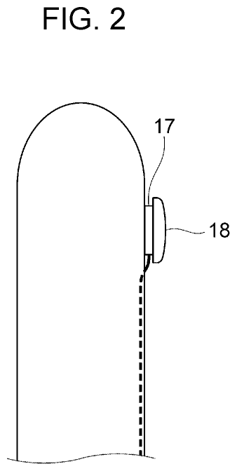

FIG. 2 illustrates an example of the configuration of the electrode. The electrode includes a pressure sensor 17 and a cushion layer 18.

The pressure sensor 17 is fixed to the holding unit 10, and measures the pressure with which the user pushes or holds the agricultural product. The pressure sensor 17 includes a diaphragm as a pressure receiving unit, for example, and measures a pressure from variations in resistance caused by deformation of the diaphragm.

The pressure sensor 17 is an example of a pressure measurement unit. While a configuration in which the pressure sensor 17 is provided between the electrode and the finger is illustrated in FIG. 2, the present disclosure is not limited thereto. The pressure sensor 17 and the electrode may be provided separately.

The cushion layer 18 is provided on the side of the electrode to be in contact with the agricultural product. With the electrode including the cushion layer 18, it is possible to suppress the agricultural product being damaged when the electrode contacts the agricultural product.

The surface of the cushion layer 18 is covered by a cloth made of conductive fibers, for example. A current output from the electrode flows through the agricultural product via the cloth.

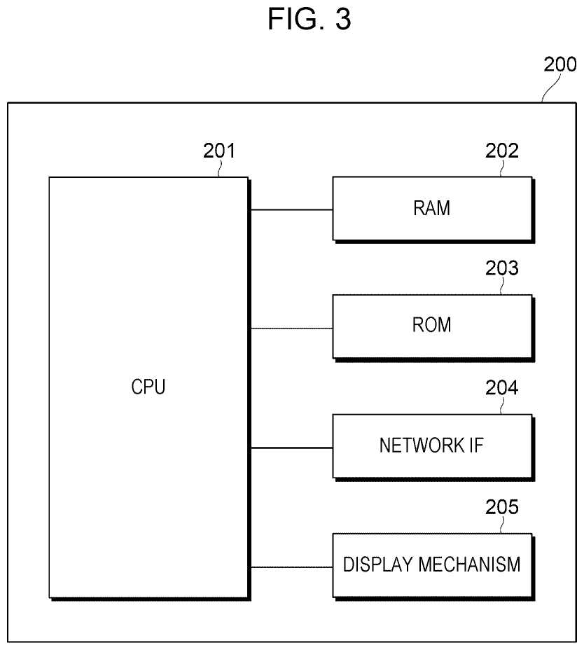

FIG. 3 illustrates an example of the hardware configuration of a computer 200 that is used as the control device 20.

The computer 200 includes a central processing unit (CPU) 201, a random access memory (RAM) 202, and a read only memory (ROM) 203. The RAM 202 is a volatile memory that is used as a work area when the CPU 201 executes a program. The ROM 203 is a non-volatile memory that stores the program executed by the CPU 201 and other data. The CPU 201 executes the program read from the ROM 203 using the RAM 202 as a work area.

The computer 200 also includes a network interface (IF) 204 for communication via a network and a display mechanism 205 for display output on the display unit 16.

The CPU 201 is a processor that performs control for the function of the measurement device 1 through execution of various types of software such as an operating system (OS) and application software. In the present exemplary embodiment, various processes are executed by a desired computer. The desired computer may execute the processes through a processor as hardware, a program as software, or a combination of these. In that event, the processor is configured to execute the various processes according to the present exemplary embodiment in cooperation with the program, and may function as the various units according to the present exemplary embodiment. The order of execution of the processes by the processor is not limited to the order in the description, and may be changed as appropriate. The desired computer may be a general-purpose computer, a special-purpose computer, a work station, or other systems that may execute various processes.

The processor may be constituted by one or more pieces of hardware, and the type of the hardware is not limited. For example, the processor may be constituted by hardware such as a central processing unit (CPU), a micro processing unit (MPU), a programmable logic device such as a field programmable gate array (FPGA), a dedicated circuit that executes a specific process such as an application specific integrated circuit (ASIC), a graphic processing unit (GPU), or a neural processing unit (NPU).

The type of the hardware may be a combination of different types of hardware. When a plurality of pieces of hardware are configured to execute one or more processes by a certain processor, the plurality of pieces of hardware may be present in devices that are physically away from each other, or may be present within the same device. In any exemplary embodiment, the order of the processes by the processor is not limited to the order discussed above, and may be changed as appropriate. The hardware is constituted by an electric circuit (circuitry), etc., formed by combining circuit elements such as semiconductor elements.

Further, the program may be software such as firmware or a microcode. The program may be a program module group, for example, and the functions of the program module group may be implemented by a processor configured to execute such functions. The program may be a program code or a plurality of code segments stored in one or more non-transitory computer-readable media (e.g., storage media, other storages, etc.). The program may be stored in a distributed manner in a plurality of non-transitory computer-readable media that are present in devices that are physically away from each other.

The program code or the code segments may represent any combination of procedures, functions, subprograms, routines, subroutines, modules, software packages, classes, or commands, data structures, or program statements. The program code or the code segments may be connected to other code segments or a hardware circuit by transmitting and receiving information, data, arguments, parameters, or memory contents.

### Functional Configuration of Control Device

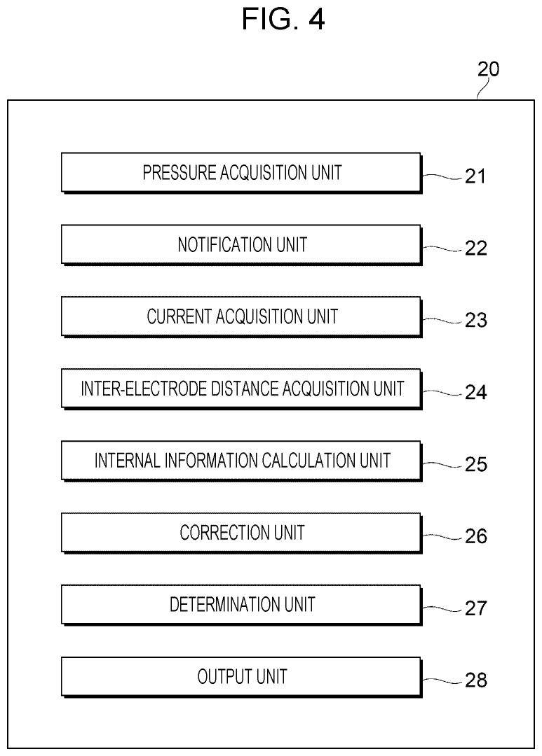

FIG. 4 illustrates an example of the functional configuration of the control device 20.

The control device 20 includes, as the functions executed by the CPU 201 as the processor, a pressure acquisition unit 21, a notification unit 22, a current acquisition unit 23, an inter-electrode distance acquisition unit 24, an internal information calculation unit 25, a correction unit 26, a determination unit 27, and an output unit 28.

The pressure acquisition unit 21 acquires a pressure measured by the pressure sensor 17. The pressure acquisition unit 21 acquires variations in resistance caused by deformation of the diaphragm of the pressure sensor 17 as an electrical signal, for example.

The notification unit 22 notifies the user that the pressure measured by the pressure sensor 17 has become a value determined in advance. The internal state is measured when the pressure is at the value determined in advance. The relationship between the pressure and the measurement result of the internal state will be discussed in detail later.

The current acquisition unit 23 acquires a current that flows between the electrodes. The current acquisition unit 23 acquires a current that flows between the electrodes from a detection circuit (not illustrated), for example. The detection circuit amplifies a signal related to a measured current, and transmits the signal to the current acquisition unit 23. The sensitivity of current detection by the detection circuit may be adjusted in accordance with the kind of the agricultural product.

The inter-electrode distance acquisition unit 24 acquires the distance between the first electrode 11 and the second electrode 12. The inter-electrode distance acquisition unit 24 calculates the distance between the electrodes by acquiring a bend at each distance sensor, for example.

The internal information calculation unit 25 calculates the impedance of the agricultural product, for example, as internal information on the agricultural product. The internal information is information about the internal state of the agricultural product. The impedance is calculated from the current that flows between the electrodes. The internal information calculation unit 25 calculates the impedance on the basis of a calibration curve prepared in advance and indicating the correlation between the current and the impedance, for example. The internal information calculation unit 25 may calculate a sugar content, a ripeness level, etc., on the basis of the impedance. The internal information will be discussed in detail later.

The correction unit 26 corrects the internal information calculated by the internal information calculation unit 25 on the basis of the distance between the electrodes. An error may be caused in the correlation between the current and the internal information, depending on the size of the agricultural product, even for agricultural products of the same kind. It is possible to improve the accuracy in measuring the internal state by the correction unit 26 making corrections on the basis of the distance between the electrodes.

The determination unit 27 determines whether the measurement result is good or not. Whether the measurement result is good or not may be whether the agricultural product may be harvested or not, for example. The determination unit 27 may determine whether the agricultural product is ready for shipping or not, or whether the agricultural product is ready to eat or not, in accordance with the stage in which the measurement device 1 is used.

The output unit 28 outputs the measurement result. The output unit 28 may output the determination result from the determination unit 27 together, or may output the determination result alone. The output unit 28 causes the display unit 16 to display the measurement result, for example. The output unit 28 may output the measurement result to an external device such as a personal computer (PC) via the network IF 204 in FIG. 3. The external device is equipped with software that estimates the harvest season on the basis of the measurement result, for example, assisting the user in determining the harvest season.

### Use of Pressure

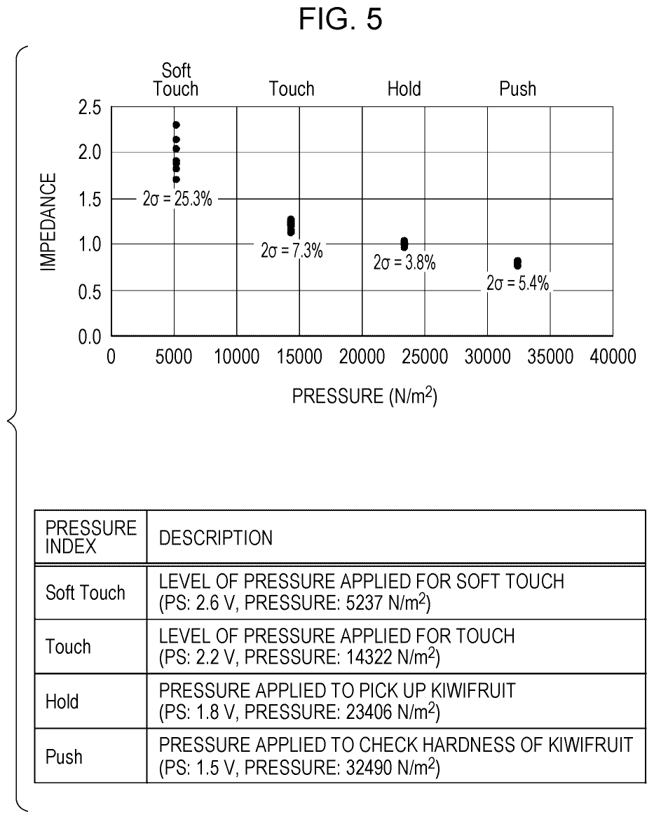

FIG. 5 indicates the relationship between the pressure and the measurement result of the impedance. The horizontal axis indicates the pressure (N/m²) with which the user pushes or holds the agricultural product. The vertical axis indicates a normalized value of the impedance.

FIG. 5 indicates fluctuations in the measurement result caused when the impedance is measured while holding the agricultural product at four pressure indices.

In FIG. 5, the four pressure indices are Soft Touch, Touch, Hold, and Push. Soft Touch is the level of pressure applied to softly touch the agricultural product, and corresponds to an output (PS) of the pressure sensor 17 of 2.6 V and a pressure of 5237 N/m². Touch is the level of pressure applied to touch the agricultural product, and corresponds to an output (PS) of the pressure sensor 17 of 2.2 V and a pressure of 14322 N/m². Hold is a pressure applied to pick up a kiwifruit, and corresponds to an output (PS) of the pressure sensor 17 of 1.8 V and a pressure of 23406 N/m². Push is a pressure applied to check the hardness of a kiwifruit, and corresponds to an output (PS) of the pressure sensor 17 of 1.5 V and a pressure of 32490 N/m².

When the pressure index is Soft Touch, 2σ is equal to 25.3% when the standard deviation is σ, which results in significant fluctuations in the measurement. When the pressure index is Touch, 2σ is equal to 7.3%, which results in small fluctuations. Moreover, 2σ is equal to 3.8% when the pressure index is Hold, and 2σ is equal to 5.4% when the pressure index is Push, which results in small fluctuations. From the above, there are small fluctuations in the measurement when the pressure index is Touch, Hold, and Push, which enables accurate measurement. The pressure may be used to measure the internal state on the basis of such pressure indices. The internal state is measured when the user pushes or holds the agricultural product with the pressure index Touch, for example.

### Measurement of Internal Information

The impedance as the internal information calculated by the internal information calculation unit 25 (see FIG. 4) is used to calculate the ripeness level or the sugar content of the agricultural product, for example. The ripeness level and the sugar content are an example of the internal state of the agricultural product. The internal information on the agricultural product will be described below using Shine Muscat as an example.

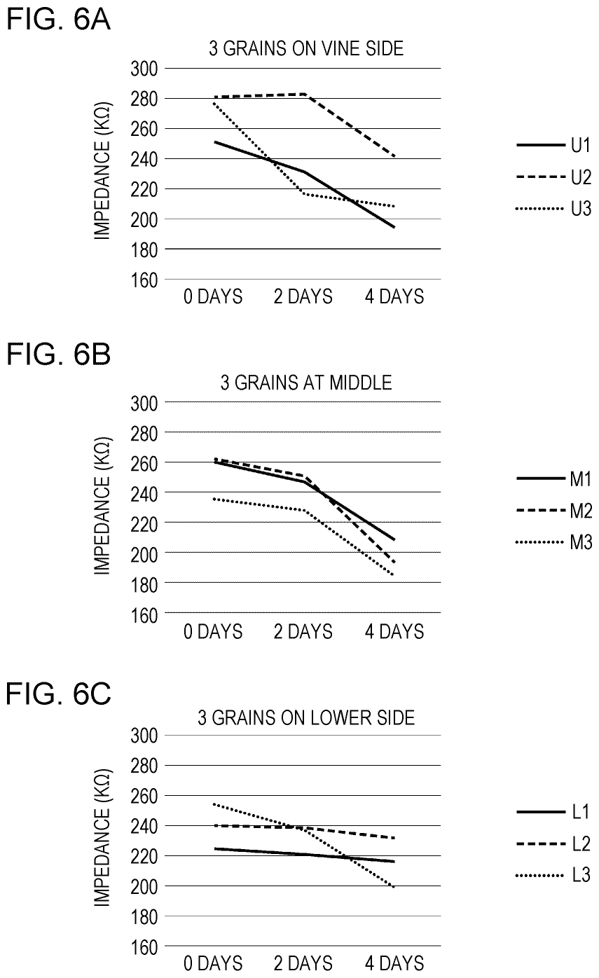

FIGS. 6A to 6C indicate temporal variations in the impedance of Shine Muscat. FIG. 6A indicates measurement values for three grains on the vine side, FIG. 6B indicates measurement values for three grains at the middle, and FIG. 6C indicates measurement values for three grains on the lower side. The horizontal axis indicates the time (days). The vertical axis indicates the impedance (kΩ).

As indicated in FIGS. 6A to 6C, the impedance reduces as days pass at any portion. The impedance reduces as Shine Muscat ripens, and therefore the ripeness level may be estimated from the impedance. The internal information calculation unit 25 (see FIG. 4) calculates the ripeness level on the basis of the correlation between the impedance and the ripeness level, for example.

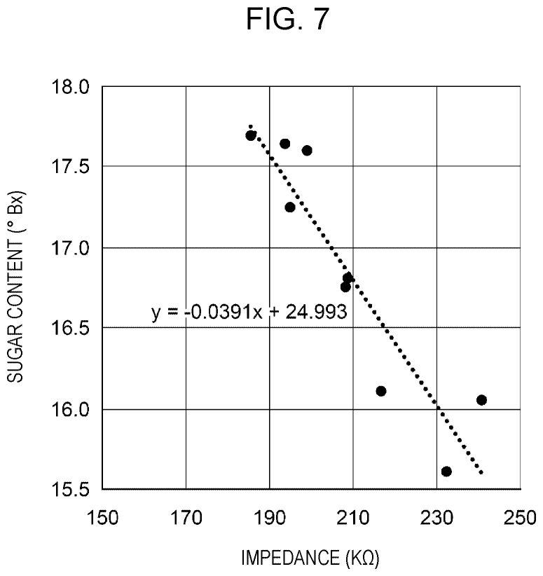

FIG. 7 indicates the relationship between the impedance and the sugar content. The horizontal axis indicates the impedance (kΩ). The vertical axis indicates the sugar content (°Bx).

FIG. 7 is a scatter diagram of the result of measuring the impedance and the sugar content. As indicated in FIG. 7, a correlation is found between the impedance and the sugar content, and an approximate curve y=−0.0391x+24.993 is obtained. The error in the sugar content meets 2σ≤0.5, and a correlation is identified. The internal information calculation unit 25 (see FIG. 4) calculates the sugar content from the impedance using the approximate curve indicated in FIG. 7, for example.

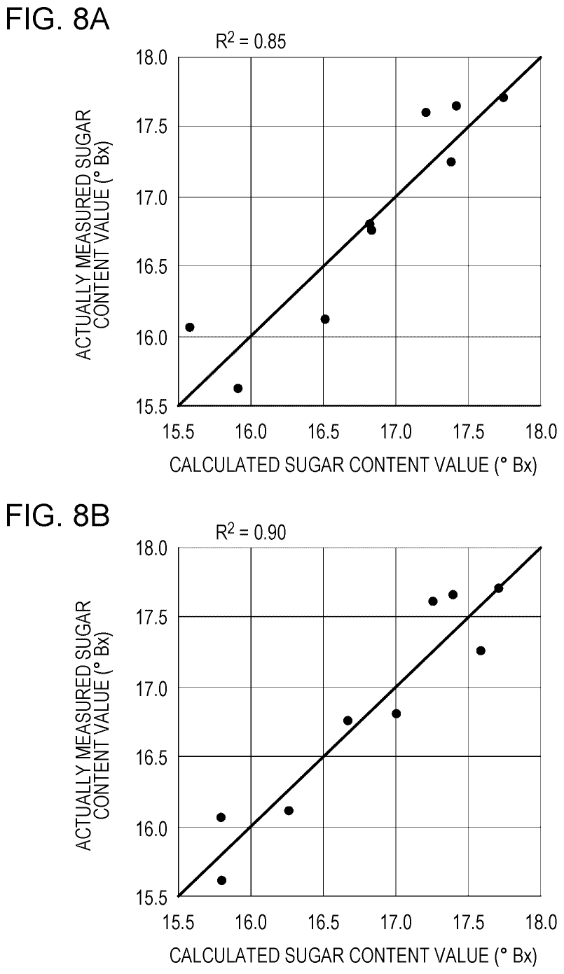

FIGS. 8A and 8B indicate a comparison between sugar content values calculated from the impedance and actually measured sugar content values. FIG. 8A indicates the result for a case where a correction is not performed in accordance with the inter-electrode distance, and FIG. 8B indicates the result for a case where a correction is performed in accordance with the inter-electrode distance.

When a correction is not performed in accordance with the inter-electrode distance, the R² value of the approximate curve is 0.85. The error in the sugar content is 2σ=0.46. When a correction is performed in accordance with the inter-electrode distance, on the other hand, the R² value of the approximate curve is 0.90. The error in the sugar content is 2σ=0.36. Fluctuations in the measurement result are small in either case, and a more accurate measurement result is confirmed when a correction is performed in accordance with the inter-electrode distance.

### Measurement Target

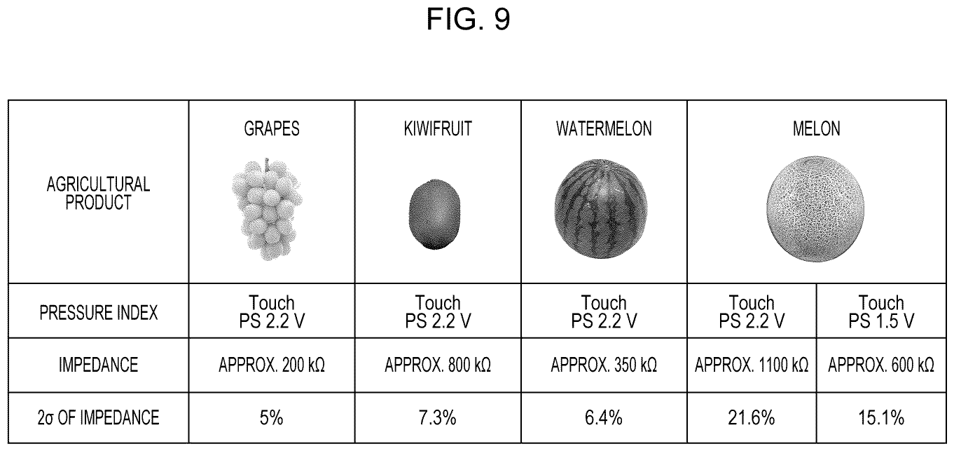

FIG. 9 indicates the result of evaluating the applicable range of the measurement device 1.

The impedance is measured for grapes, a kiwifruit, a watermelon, and a melon using the measurement device 1. When the impedance is measured for the agricultural products at the pressure index Touch indicated in FIG. 5, the impedance is approximately 200 kΩ, 800 kΩ, 350 kΩ, and 1100 kΩ, respectively. In addition, 2σ of the measured impedance is 5%, 7.3%, 6.4%, and 21.6%, respectively. While the watermelon and the melon have skins with about the same thickness, fluctuations in the measurement result for the melon which has an uneven surface are greater than those for the watermelon.

The impedance is measured at the pressure index Push for the melon which exhibits greater fluctuations in the measurement result at the pressure index Touch. The measurement exhibits an impedance of approximately 600 kΩ, which results in 2σ of the measured impedance of 15.1%. In this manner, it is possible to measure the internal state using the measurement device 1 for a variety of agricultural products, by changing the pressure even when the agricultural product has an uneven surface. The measurement device 1 may measure the internal state using the pressure with which the user pushes or holds the agricultural product. For example, the measurement device 1 starts measuring the internal state when the pressure with which the user pushes or holds the agricultural product becomes the pressure index indicated in FIG. 9. Alternatively, the measurement device 1 may be configured to make a measurement when the pressure with which the user pushes or holds the agricultural product is within a range determined in advance.

When the agricultural product has a shape similar to grapes, the measurement may be made by picking each grain, or the measurement may be made by interposing a plurality of grains between the electrodes when the grains are small.

### Process Flow by Control Device

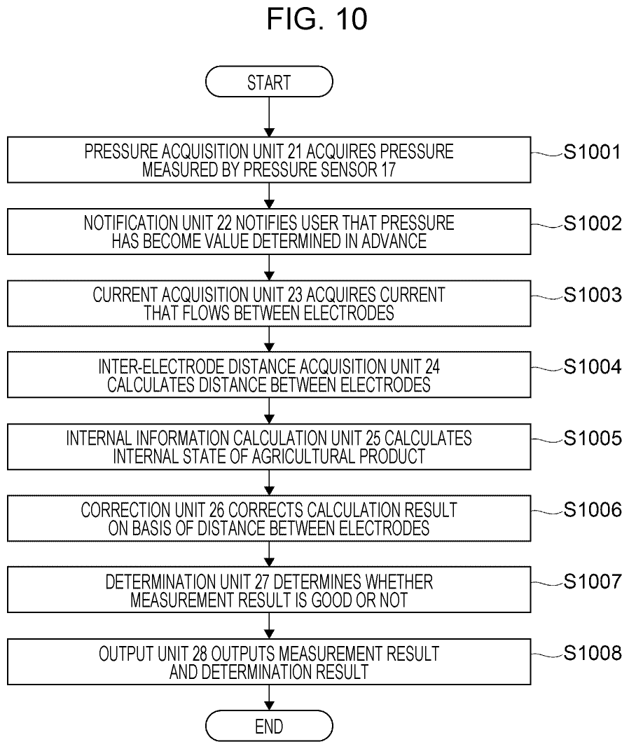

FIG. 10 is a flowchart illustrating an example of a process flow by the control device 20. Here, an example in which the user uses the measurement device 1 in harvesting the agricultural product will be described. The internal state is measured by the user wearing the holding unit 10 in a glove shape on his/her hand and grabbing the agricultural product with the thumb portion and the middle finger portion on which the electrodes are provided. The control device 20 of the measurement device 1 stores the data indicated in FIGS. 5, 6A to 6C, 7, 8A and 8B, and 9, for example, and the internal state is measured on the basis of the stored data.

In FIG. 10, first, the pressure acquisition unit 21 acquires a pressure measured by the pressure sensor 17 (step 1001). Then, the notification unit 22 notifies the user that the pressure has become a value determined in advance (step 1002). The user confirms that the pressure has become the value determined in advance by a sound, for example. Alternatively, the user may confirm that the pressure has become the value determined in advance by blinking light.

Next, the current acquisition unit 23 acquires a current that flows between the electrodes (step 1003). The current acquisition unit 23 acquires a current that flows between the electrodes when the pressure is at the value determined in advance. The application of a voltage to the electrodes may be started when the pressure has become the value determined in advance.

Next, the inter-electrode distance acquisition unit 24 calculates the distance between the electrodes (step 1004). The inter-electrode distance acquisition unit 24 calculates the distance between the electrodes by acquiring bends at the thumb, the root of the thumb, and the middle finger from the distance sensors.

Next, the internal information calculation unit 25 calculates the internal state of the agricultural product (step 1005). The internal information calculation unit 25 calculates an impedance from the current that flows between the electrodes using a calibration curve prepared in advance. In addition, the internal information calculation unit 25 calculates the sugar content of the agricultural product on the basis of the impedance.

Next, the correction unit 26 corrects the calculation result on the basis of the distance between the electrodes (step 1006). The measurement accuracy is improved as indicated in FIGS. 8A and 8B by correcting the effect of the distance between the electrodes on the impedance measurement.

Next, the determination unit 27 determines whether the measurement result is good or not (step 1007). The determination unit 27 determines, on the basis of the impedance after being corrected by the correction unit 26, whether or not the agricultural product is suitable to be harvested. The determination unit 27 determines that the agricultural product is suitable to be harvested when the impedance is less than a threshold determined in advance, for example.

Next, the output unit 28 outputs the measurement result and the determination result (step 1008). The output unit 28 causes the display unit 16 to display the sugar content of the agricultural product and whether or not the agricultural product is suitable to be harvested.

### Agricultural Product Production Method

The user that produces the agricultural product may produce the agricultural product using the measurement device 1. The user measures the internal state of the agricultural product using the measurement device 1, and harvests the agricultural product by specifying the harvest season of the agricultural product in accordance with the measurement result.

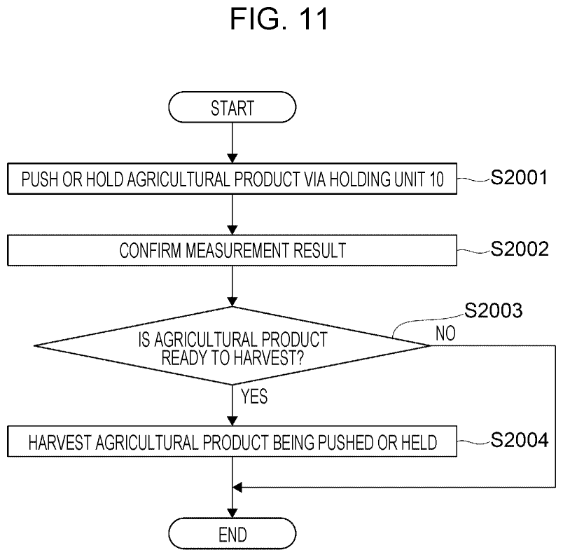

FIG. 11 is a flowchart illustrating an example of a method of measuring the internal state of an agricultural product in a production process of the agricultural product.

First, the user pushes or holds the agricultural product via the holding unit 10 (step 2001). The user wears the holding unit 10 in a glove shape on his/her hand, for example, and grabs the agricultural product using the single hand, for example. The internal information is measured when the pressure with which the user grabs the agricultural product has become a value determined in advance. The user confirms that the pressure with which he/she grabs the agricultural product has become a value determined in advance by being notified by a sound, for example.

When the measurement is completed, the user confirms the measurement result (step 2002). The measurement result is displayed on the display unit 16. In addition, the determination result as to whether the agricultural product is ready to harvest or not is displayed on the display unit 16, together with the measurement result. When the agricultural product is ready to harvest (YES in step 2003), the user harvests the agricultural product being pushed or held (step 2004). The user harvests the agricultural product using scissors held by the hand opposite to the hand pushing or holding the agricultural product.

When the agricultural product is not ready to harvest (NO in step 2003), on the other hand, the flow is ended. The user repeatedly performs the processes in steps 2001 to 2004 for the agricultural products in the farm that he/she owns.

While an exemplary embodiment of the present disclosure has been described above, the technical scope of the present disclosure is not limited to the above exemplary embodiment described above. A variety of modifications and improvements that may be made to the above exemplary embodiment also fall within the technical scope of the present disclosure.

For example, the internal state may be measured by a method other than by measuring a current, and the internal state may be measured using light or sound waves. When the internal state is measured using light, the holding unit 10 is provided with an irradiation unit that radiates light and a light reception unit that receives reflected light. When the user pushes or holds the agricultural product via the holding unit, light is radiated from the irradiation unit to the agricultural product to measure the internal state.

The output unit 28 may provide the measurement result with position information, and display the measurement result on a map while reflecting the position information. This makes it possible to determine the harvest season on the map.

The holding unit 10 in a glove shape may be constituted from an inner glove provided with the electrodes and an outer glove that covers the inner glove. The double structure protects inner wires. This also makes it possible to wash the outer glove when soiled.

The measurement device 1 may be used not only by producers of agricultural products, but also by retail stores and consumers. For example, at the retail stores, the user checks the ripeness level and the shelf life of the agricultural product using the measurement device 1. The user may perform a measurement action, a displaying action, a transporting action, etc., in the same process.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A measurement device comprising:
a holding unit that is deformed in accordance with motion of a hand of a user to push or hold an agricultural product; and
a measurement unit that is provided on the holding unit to measure an internal state of the agricultural product being pushed or held.
(((2)))

The measurement device according to (((1))),
wherein the holding unit is worn on the hand of the user.
(((3)))

The measurement device according to (((2))),
wherein the holding unit is in a glove shape.
(((4)))

The measurement device according to any one of (((1))) to (((3))), further comprising:
a pressure measurement unit that measures a pressure with which the user pushes or holds the agricultural product.
(((5)))

The measurement device according to (((4))), further comprising:
an output unit that outputs a measurement result from the measurement unit,
wherein the output unit outputs the measurement result for the pressure measured by the pressure measurement unit in a range determined in advance.
(((6)))

The measurement device according to (((4))), further comprising:
a notification unit that notifies the user that the pressure measured by the pressure measurement unit has become a value determined in advance.
(((7)))

The measurement device according to any one of (((1))) to (((6))),
wherein the measurement unit includes at least two electrodes, and measures an impedance of the agricultural product from a current that flows when a voltage is applied to the electrodes.
(((8)))

The measurement device according to (((7))),
wherein the measurement device is a glove that is worn on one hand to be used, and one of the at least two electrodes is provided at a thumb portion of the glove.
(((9)))

The measurement device according to (((7))), further comprising:
a distance measurement unit that measures a distance between the at least two electrodes, and
a correction unit that corrects a measurement result from the measurement unit on a basis of the distance measured by the distance measurement unit.
(((10)))

The measurement device according to (((7))),
wherein the electrodes include a cushion layer with a surface covered with conductive fibers.
(((11)))

The measurement device according to (((7))),
wherein the voltage applied to the electrodes is an alternating voltage, and a frequency of the alternating voltage is set to be different in accordance with a kind of the agricultural product.
(((12)))

The measurement device according to any one of (((1))) to (((11))), further comprising:
a determination unit that determines whether a measurement result from the measurement unit is good or not, and
an output unit that indicates a determination result from the determination unit.
(((13)))

The measurement device according to (((1))),
the measurement unit includes an irradiation unit that radiates light to the agricultural product, and a light reception unit that receives reflected light of the light.
(((14)))

The measurement device according to any one of (((1))) to (((13))), further comprising:
an output unit that provides a measurement result from the measurement unit with position information, and that displays the measurement result on a map while reflecting the position information.
(((15)))

An agricultural product production method comprising:
measuring an internal state of the agricultural product using the measurement device according to any one of (((1))) to (((14))); and
harvesting the agricultural product by specifying a harvest season of the agricultural product in accordance with a measurement result.

What is claimed is:

1. A measurement device comprising:
a holding unit that is deformed in accordance with motion of a hand of a user to push or hold an agricultural product; and
a measurement unit that is provided on the holding unit to measure an internal state of the agricultural product being pushed or held.

2. The measurement device according to claim 1,
wherein the holding unit is worn on the hand of the user.

3. The measurement device according to claim 2,
wherein the holding unit is in a glove shape.

4. The measurement device according to claim 1, further comprising:
a pressure measurement unit that measures a pressure with which the user pushes or holds the agricultural product.

5. The measurement device according to claim 4, further comprising:
an output unit that outputs a measurement result from the measurement unit,
wherein the output unit outputs the measurement result for the pressure measured by the pressure measurement unit in a range determined in advance.

6. The measurement device according to claim 4, further comprising:
a notification unit that notifies the user that the pressure measured by the pressure measurement unit has become a value determined in advance.

7. The measurement device according to claim 1,
wherein the measurement unit includes at least two electrodes, and measures an impedance of the agricultural product from a current that flows when a voltage is applied to the electrodes.

8. The measurement device according to claim 7,
wherein the measurement device is a glove that is worn on one hand to be used, and one of the at least two electrodes is provided at a thumb portion of the glove.

9. The measurement device according to claim 7, further comprising:
a distance measurement unit that measures a distance between the at least two electrodes; and
a correction unit that corrects a measurement result from the measurement unit on a basis of the distance measured by the distance measurement unit.

10. The measurement device according to claim 7,
wherein the electrodes include a cushion layer with a surface covered with conductive fibers.

11. The measurement device according to claim 7,
wherein the voltage applied to the electrodes is an alternating voltage, and a frequency of the alternating voltage is set to be different in accordance with a kind of the agricultural product.

12. The measurement device according to claim 1, further comprising:
a determination unit that determines whether a measurement result from the measurement unit is good or not; and
an output unit that indicates a determination result from the determination unit.

13. The measurement device according to claim 1,
the measurement unit includes an irradiation unit that radiates light to the agricultural product, and a light reception unit that receives reflected light of the light.

14. The measurement device according to claim 1, further comprising:
an output unit that provides a measurement result from the measurement unit with position information, and that displays the measurement result on a map while reflecting the position information.

15. An agricultural product production method comprising:
measuring an internal state of the agricultural product using the measurement device according to claim 1; and
harvesting the agricultural product by specifying a harvest season of the agricultural product in accordance with a measurement result.

16. An agricultural product production method comprising:
measuring an internal state of the agricultural product using the measurement device according to claim 2; and
harvesting the agricultural product by specifying a harvest season of the agricultural product in accordance with a measurement result.

17. An agricultural product production method comprising:
measuring an internal state of the agricultural product using the measurement device according to claim 3; and
harvesting the agricultural product by specifying a harvest season of the agricultural product in accordance with a measurement result.

18. An agricultural product production method comprising:
measuring an internal state of the agricultural product using the measurement device according to claim 4; and
harvesting the agricultural product by specifying a harvest season of the agricultural product in accordance with a measurement result.

19. An agricultural product production method comprising:
measuring an internal state of the agricultural product using the measurement device according to claim 5; and
harvesting the agricultural product by specifying a harvest season of the agricultural product in accordance with a measurement result.

20. An agricultural product production method comprising:
measuring an internal state of the agricultural product using the measurement device according to claim 6; and
harvesting the agricultural product by specifying a harvest season of the agricultural product in accordance with a measurement result.
